(19) United States
(12) Patent Application Publication
(10) Pub. No.: US 2015/0059548 A1
(43) Pub. Date: Mar. 5, 2015

(54) CUTTING DEVICES

(71) Applicant: MAKITA CORPORATION, Anjo-shi (JP)

(72) Inventor: Toshiyuki KANI, Anjo-shi (JP)

(21) Appl. No.: 14/457,822

(22) Filed: Aug. 12, 2014

(30) Foreign Application Priority Data
Aug. 27, 2013 (JP) 2013-175435

(51) Int. Cl. B27B 5/20

(52) U.S. Cl. CPC B27B 5/208
USPC 83/473; 83/491

(57) ABSTRACT

A cutting device may include an electric motor, a cutting blade, a clamp device and a drive system. The clamp device may include a first flange and a second flange configured to clamp the cutting blade therebetween. The drive system may transmit rotation of the electric motor to the cutting blade via the first flange.

This application claims priority to Japanese patent application serial number 2013-175435, the contents of which are incorporated herein by reference.

### BACKGROUND OF THE INVENTION

1. Field of the Invention

Embodiments of the present invention relate to cutting devices such as table-type cutting devices and portable cutting devices.

2. Description of the Related Art

Typically, a table-type cutting device may have a table and a cutting unit movable relative to the table. The cutting unit may include a cutting blade such as a circular grinding wheel or a circular saw blade. The cutting unit may be moved downward relative to the table for performing a cutting operation of a workpiece supported on the table. In this specification, the term “cutting operation” may be used to define various operations. For example, one operation would be for separating a workpiece into two or more pieces. A second operation would be an operation for forming a groove into a workpiece without separating the workpiece. A third operation would be for trimming or grinding a workpiece.

There has been known a table-type cutting device that includes a table for supporting a workpiece, and a cutting unit having a circular rotary tool (such as a circular saw blade) which is vertically and laterally supported on the table. This type of cutting device may allow a normal vertical cutting operation, a miter cut operation or an inclined cutting operation. In the vertical cutting operation, the surface of the circular rotary tool extends vertically relative to the surface of the table. In a miter cut operation, a workpiece is cut obliquely from the edge thereof while the table is rotated by a given angle. In an inclined cutting operation, a workpiece is cut obliquely relative to a direction of thickness thereof while the cutting unit is inclined leftward or rightward from the vertical position.

US2009/0151529 discloses some techniques relating to a cutting device that can be used for performing both the miter cut operation and the inclined cut operation. According to the disclosed techniques, the rotary output of an electric motor as a drive source is reduced through a reduction gear train and is thereafter output to a spindle. Due to this arrangement, the electric motor can be located at a high position away from the spindle. In addition, the electric motor is oriented obliquely downward so as to be inclined relative to the axis of the spindle. In this way, the inclination angle of the cutting unit toward the right side (the side of the electric motor) can be set to a large value without causing interference with the workpiece. Because the cutting unit can be inclined to the right by a large inclination angle, it may be possible to increase possible variations in the cutting operation.

However, because the reduction gear train includes a gear mounted to the spindle, the size of the cutting device in the axial direction around the cutting blade is necessary to accommodate this arrangement. This leads to a limitation in the maximum incline angle.

Therefore, there has been a need in the art for reducing the size around the cutting blade of the cutting device in the axial direction of the cutting blade.

### SUMMARY OF THE INVENTION

In one aspect according to the present teachings, a cutting device may include an electric motor, a cutting blade, a clamp device and a drive system. The clamp device may include a first flange and a second flange configured to clamp the cutting blade therebetween. The drive system may transmit rotation of the electric motor to the cutting blade via the first flange.

### BRIEF DESCRIPTION OF THE DRAWINGS

FIG. 1 is a side view of a cutting device according to a representative embodiment;

FIG. 2 is a plan view of the cutting device as viewed in a direction indicated by arrow II in FIG. 1;

FIG. 3 is a front view of the cutting device as viewed in a direction indicated by arrow III in FIG. 1; and

FIG. 4 is a vertical sectional view of a part of a cutting unit of the cutting device showing a vertical sectional view of a drive system.

### DETAILED DESCRIPTION OF THE INVENTION

In one embodiment, a cutting device may include an electric motor, a cutting blade, a clamp device and a drive system. The clamp device may include a first flange and a second flange configured to clamp the cutting blade therebetween. The drive system may be configured to transmit rotation of the electric motor to the cutting blade and may include a belt transmission mechanism. The belt transmission mechanism may include a drive pulley, a driven pulley and a belt extending between the drive pulley and the driven pulley. The driven pulley may be coupled to the first flange of the clamp device.

With this arrangement, because the rotation of the electric motor may be transmitted to the cutting blade via the first flange of the clamp device, it is not necessary to provide a gear or the like separately from the clamp device for transmitting rotation to the cutting blade. Therefore, it is possible to eliminate space necessary for a separate gear or the like. As a result, it is possible to reduce the space occupied by the drive system around the cutting blade.

In addition, because the belt transmission mechanism is used for transmitting rotation to the first flange of the clamp device, it is possible to increase the distance between the axis of the electric motor and the axis of the cutting blade. Therefore, in particular when the cutting device has a table or a base for placing a workpiece thereon and that the cutting blade is tiltable relative to the table or the base, it is possible to increase the maximum tiltable angle of the cutting blade.

The driven pulley may be integrated with the first flange. For example, the driven pulley may be formed integrally with the first flange. With this construction, the drive system may be simplified.

The cutting device may further include a drive housing and a spindle rotatably supported within the drive housing via a bearing. The cutting blade may be mounted to the spindle while the cutting blade being clamped between the first flange and the second flange. The bearing may be disposed within the drive housing such that the bearing overlaps the first flange with respect to an axial direction of the spindle.

With this arrangement, it is possible to reduce the axial length of the drive system including the spindle around the cutting blade.

The cutting device may further include a spindle lock mechanism configured to lock the rotation of the spindle. The spindle lock mechanism may include a lock member and a rotational member that rotates with the spindle. The lock member may be configured to engage the rotational member. Locking the spindle by the spindle lock mechanism may facilitate the clamping and unclamping operation of the clamp device, so that the cutting blade can be rapidly mounted and removed.

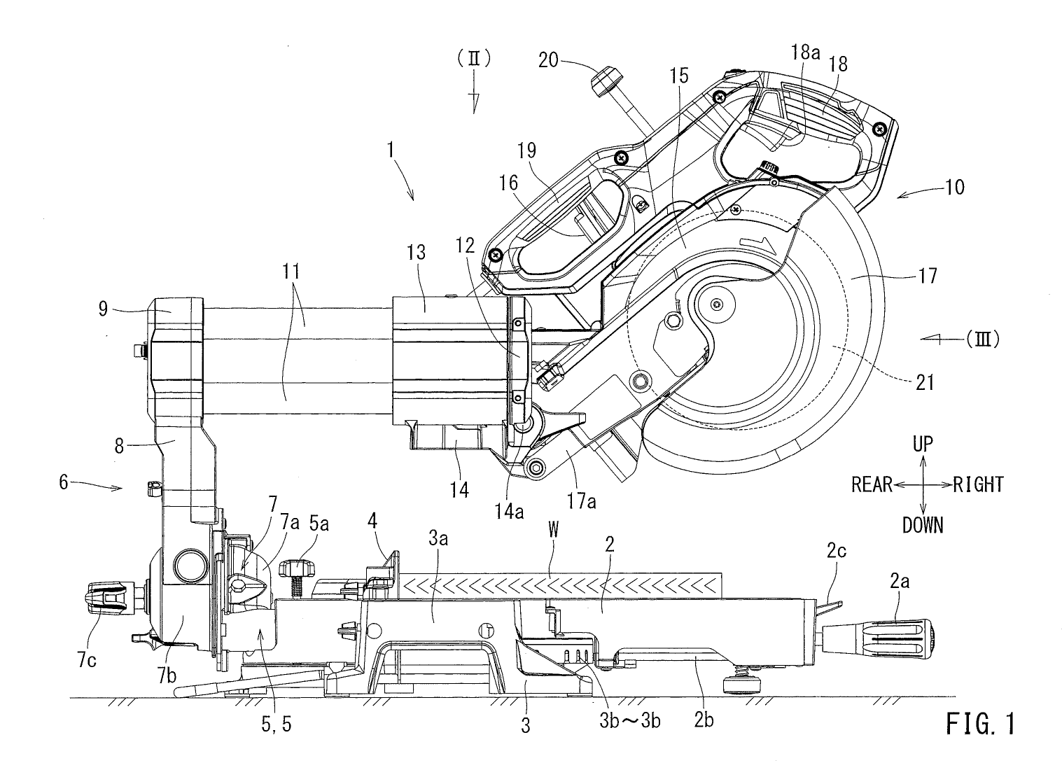

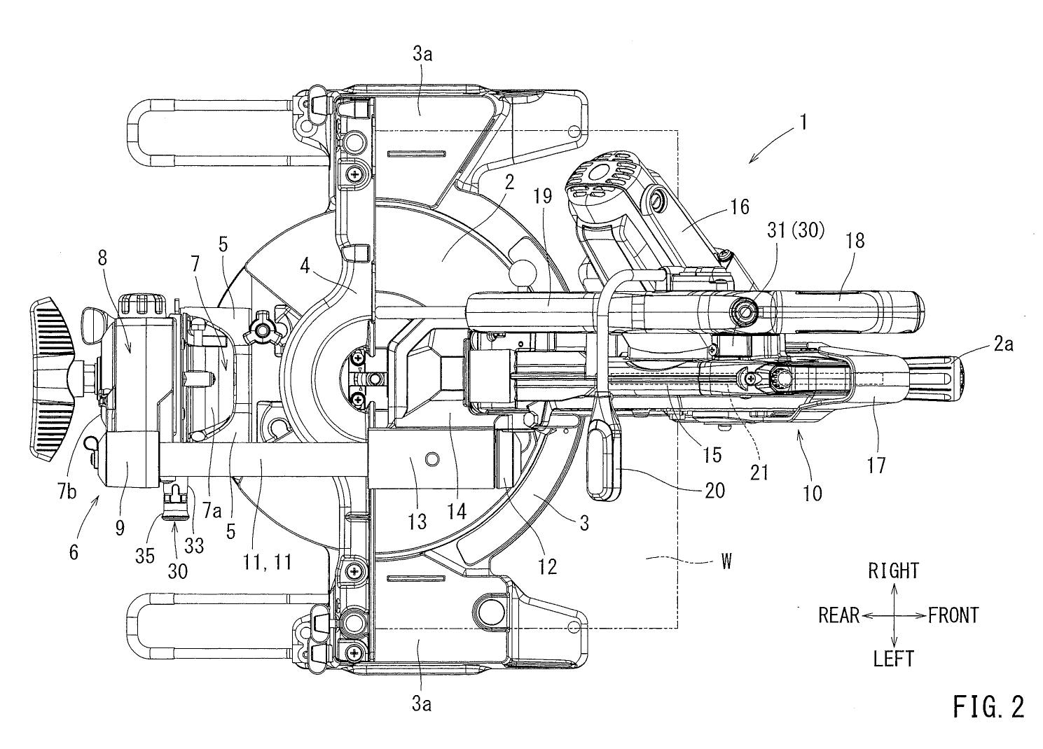

A representative embodiment will now be described with reference to FIGS. 1 to 4. Referring to FIG. 1, there is shown a cutting device 1 according to the representative embodiment. In order to operate the cutting tool 1, the user may be positioned on the right side as viewed in FIG. 1 of the cutting device 1. In the following description, a front side, a rear side, a left side, a right side, an upper side and a lower side are determined with reference to the position of the user who is positioned for operating the cutting device 1. Therefore, the user may be positioned on the front side of the cutting device 1 for operating the same. The user may perform a cutting operation of a workpiece W by moving a cutting unit 10 of the cutting device 1 in a direction from the side of the user toward the rear side.

The cutting device 1 may be a so-called slide-type miter saw and may include a table 2, on which the workpiece W can be placed, and a base 3 supporting the table 2. The cutting unit 10 may be supported on the upper side of the table 2 and may be operable to move vertically relative to the table 2. The table 2 may be supported on the upper surface of the base 3 so as to be rotatable within a horizontal plane. A pair of auxiliary tables 3a may be disposed on the left and right sides of the base 3. Each of the auxiliary tables 3a may have an upper surface that extends within a same plane as the upper surface of the table 2. The workpiece W may be placed on the table 2 such that the workpiece W extends between the auxiliary tables 3a. The workpiece W may be fixed in position relative to the pair of auxiliary tables 3a by suitable clamp devices (not shown). A fence 4 may be positioned on the upper side of the table 2 for positioning the workpiece W. The fence 4 may extend between the auxiliary tables 3a while being spaced from the upper surface of the table 2 by a little distance. The fence 4 may have a positioning surface for contacting the workpiece W. The positioning surface may extend along a plane that passes through the rotational axis of the table 2 as viewed from the upper side.

A grip 2a may be provided on the front portion of the table 2. Therefore, the user can rotate the table 2 clockwise or counterclockwise by grasping the grip 2a. The rotational position of the table 2 can be locked by inserting a front end of a positioning rod 2b into any one of the positioning grooves 3b formed in the base 3. An unlock lever 2c may be vertically pivotally mounted to the table 2 at a position on the upper side of the grip 2a. Pivoting the unlock lever 2c downward can retract the positioning rod 3b forward to release the locked state of the table 2. In this released state, the table 2 can be rotated. The rotational position can be also locked by tightening the unlock lever 2c that may be threadable engaged with the table 2.

The cutting unit 10 may be supported by the table 2 via upper and lower slide mechanisms, so that the cutting unit 10 can slidably move in the forward and rearward directions.

More specifically, the rear portion of the table 2 may support a unit support 6 via the lower slide mechanism. The lower slide mechanism may include a pair of right and left slide bars 5 that are supported by corresponding bearings (not shown) so as to be slidably movable in the forward and rearward directions. The slide bars 5 can be fixed at a desired position by tightening a fixing screw 5a.

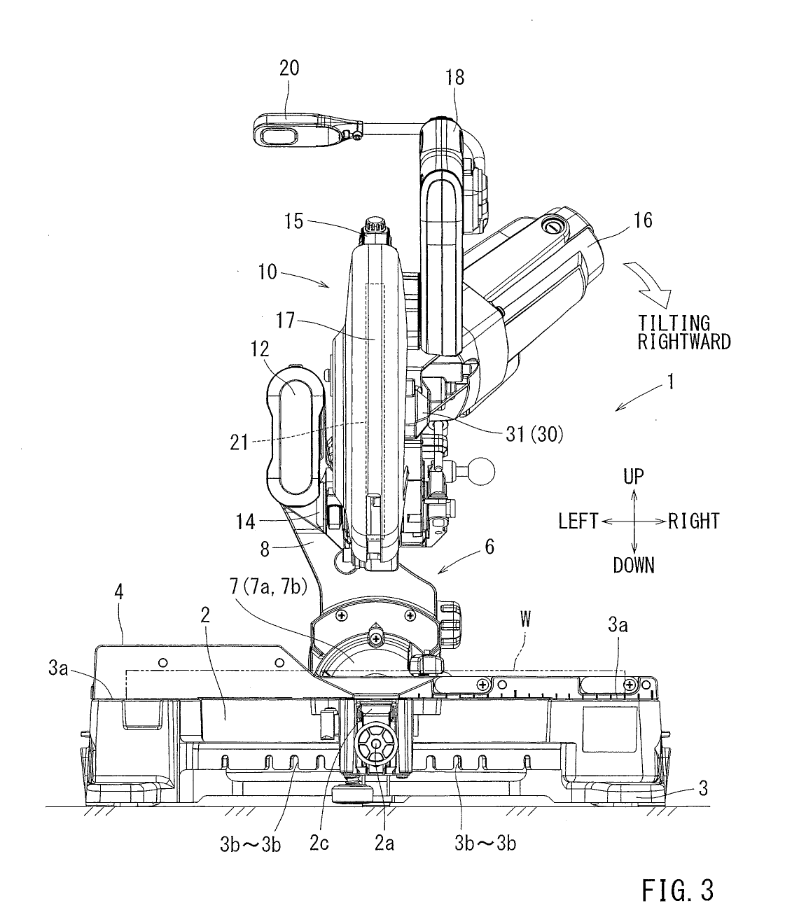

The unit support 6 may include a first tilt support device 7 and a unit support arm 8. The first tilt support device 7 may be connected to the rear portions of the pair of right and left slide bars 5. The first tilt support device 7 may allow the cutting unit 10 to be tilted leftward or rightward as viewed from the side of the user (leftward or rightward in FIG. 3), so that an inclined cutting operation can be performed. The first tilt support device 7 may include a support member 7a and a tiltable member 7b that are rotatably coupled to each other via a tilt shaft (not shown). The tilt shaft may extend in the forward and rearward directions within the same plane as the upper surface of the table 2 as viewed from the lateral side. The support member 7a may be joined to the rear portions of the pair of right and left slide bars 5. The unit support arm 8 may extend upward from the upper portion of the unit support member 7b. The first tilt support device 7 may allow the tool unit 10 to be positioned at a vertical position or at a left or right tilt position, such as a left 45° tilt position. In the vertical position, a surface of a cutting blade 21 of the tool unit 10 may extend vertically relative to the upper surface of the table 2. In the left or right tilt position, the cutting blade 21 may be inclined leftward or rightward from the vertical position. With the tool unit 10 positioned at the vertical position, a vertical cutting operation can be performed. With the tool unit 10 positioned at the right or left tilt position, an inclined cutting operation can be performed. The tool unit 10 may be fixed at the vertical position or the right or left tilt position by tightening a fixing lever 7c.

The upper slide mechanism may include a pair of slide bars 11 connected to the upper portion of the unit support arm 7b. More specifically, a slide bar holder 9 may be provided at the upper portion of the unit support arm 7b. The rear portions of the pair of slider bars 11 may be fixedly connected to the slide bar holder 9, so that the pair of slider bars 11 extend forward from the slide bar holder 9. The pair of slide bars 11 may extend parallel to each other and spaced from each other in the vertical direction. The front portions of the pair of slider bars 11 may be fixedly connected to each other via a connecting member 12.

A slider 13 may be supported on the pair of slide bars 11, so that the slider 13 can slide in the forward and rearward directions along the pair of slider bars 11 within a range between the slide bar holder 9 and the connecting member 12.

The tool unit 10 may be supported on the right side portion of the slider 13. More specifically, the tool unit 10 may be supported by the slider 13 via a second tilt support device 14, so that the tool unit 10 can tilt vertically relative to the slider 13. The tool unit 10 having the cutting blade 12 may include a unit case 15 and an electric motor 16. The unit case 15 may be vertically pivotally supported by the front side portion of the slider 13 via a tilt shaft 14a of the second tilt support device 14. The electric motor 16 may be mounted to the right side portion of the unit case 15. The cutting blade 12 may have a circular shape and may be rotatably driven by the electric motor 16. The upper portion of the cutting blade 12 may be covered by the unit case 15. A movable cover 17 may be opened and closed for uncovering and covering the lower portion of the cutting blade 12. The movable cover 17 may be coupled to a link arm 17a connected between the second tilt support device 14 and the unit case 15, so that the movable cover 17 can open and close in response to the vertical tilting movement of the cutting unit 10. When the cutting unit 10 is positioned at an uppermost position shown in FIG. 1, the movable cover 17 may be completely closed to cover the lower portion of the cutting blade 12. In this way, the unit case 15 and the movable cover 17 may cover the entire cutting blade 12. As the cutting unit 10 moves downward from the uppermost position, the movable cover 17 may pivot in a clockwise direction as viewed in FIG. 1, so that the movable cover 17 is opened. When the cutting unit 10 reaches a lowermost position, the movable cover 17 is completely opened and the uncovered lower portion of the cutting blade 21 may cut into the workpiece W.

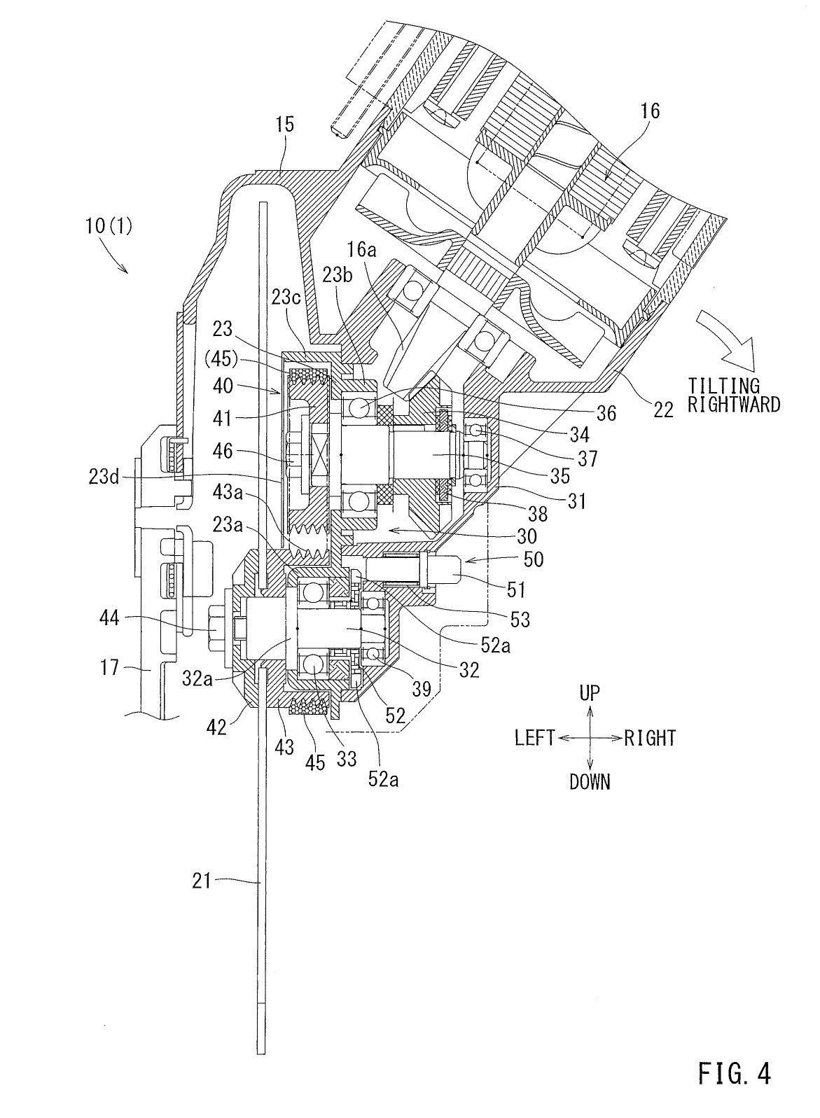

As shown in FIG. 4. a motor base 22 may be formed integrally with the right upper portion of the unit case 15. The electric motor 26 may be mounted to the motor base 22. The unit case 15 may include a main handle 18 and a sub handle 19 (see FIG. 1) located on the upper side of the electric motor 26 so as to straddle between the front portion and the rear portion of the motor base 22. Each of the main handle 18 and the sub handle 19 may be elongated in the forward and rearward directions. The sub handle 19 may be positioned on the rear side of the main handle 18.

The user may grasp the main handle 18 for vertically tilting the cutting unit 10. A switch lever 18a for starting and stopping the electric motor 16 may be positioned at the lower surface of the main handle 18. Therefore, the user who grasps the main handle 18 can pull the switch lever 18a by using fingers of the same hand that grasps the main handle 18. Pulling the switch lever 18a can start the electric motor 16, so that the cutting blade 21 rotates in the clockwise direction as viewed in FIG. 1.

The sub handle 19 may be positioned such that it extends substantially in the horizontal direction when the cutting unit 10 is positioned at the lowermost position. Although not shown in the drawings, a stopper device may be provided for fixing the cutting unit 10 at the lowermost position. With the cutting unit 10 fixed at the lowermost position, the user can carry the cutting device 1 by grasp the sub handle 19. In this way, the sub handle 19 can be used as a carrying handle.

The cutting unit 10 may further include a lightning device 20 that extends upward from a position between the main handle 18 and a sub handle 19. When the lightning device 10 is turned on, the light may be emitted to largely illuminate a region where the cutting blade 12 cuts the workpiece W, so that operations in a dark place can be facilitated.

A drive system 30 of the cutting unit 10 will now be described with reference to FIG. 4. The drive system 30 may transmit the rotation of the electric motor 16 to a spindle 32 to which the cutting blade 21 is attached. In this embodiment, the drive system 30 may include a belt transmission mechanism 40.

A drive housing 31 may be formed integrally with the motor base 22 so as to extend downward therefrom. A housing cover 23 may be positioned on the left side of the drive housing 31 so as to be opposed thereto. The drive system 30 may be disposed within a space defined between the drive housing 31 and the housing cover 23 and along the left side surface of the housing cover 23.

A drive gear 16a may be formed on an output shaft of the electric motor 16 and may engage an intermediate gear 34. The intermediate gear 34 may be a bevel gear. Therefore, the electric motor 16 may be mounted to the motor base 22 such that the output shaft is inclined downward with the right side portion of the electric motor 16 located upward of the left side portion.

The intermediate gear 34 may be mounted to a right side portion of an intermediate shaft 35. The intermediate shaft 35 may be rotatably supported by the drive housing 31 via left and right bearings 36 and 37. The left bearing 36 may be supported within a cylindrical tubular bearing holder 23b formed on the upper portion of the right side surface of the housing cover 23. A thrust bearing 38 may be mounted to the intermediate shaft 35 in order to bear against a thrust load that may be applied to the intermediate gear 34 in the right direction.

The left end of the intermediate shaft 35 may extend through the housing cover 23 to protrude into the unit case 15. A drive pulley 41 of the belt transmission mechanism 40 may be mounted to the protruding end of the intermediate shaft 35. The drive pulley 41 may be secured to the protruding end of the intermediate shaft 35 by a fixing screw 46 that is threadably engaged with the end surface of the protruding end. In this way, the drive pulley 41 may rotate together with the intermediate shaft 35. The drive pulley 41 may be disposed within a pulley accommodating portion 23c of the housing cover 23. The pulley accommodating portion 23c may have a substantially semicircular shape and may be provided on the upper portion of the left side surface of the hosing cover 23. A dust-preventing pulley cover 23d may be attached to the pulley accommodating portion 23c, so that the space within the pulley accommodating portion 23c can be shielded from within the case body 15.

The lower portion of the drive housing 31 may rotatably support the spindle 32 via left and right bearings 33 and 39. The left bearing 33 (on the side of the front end of the spindle 32) may be mounted within a cylindrical tubular bearing holder 23a provided on the housing cover 23. The bearing holder 23a may protrude toward the side of the unit case 15 (i.e. leftward). The left end portion of the spindle 32 may protrude into the unit case 15 through the bottom portion (left side portion) of the bearing holder 23a. The cutting blade 21 may be mounted to the protruding end of the spindle 32. More specifically, the cutting blade 21 may be fixed in position relative to the spindle 32 by a clamp device including a disk-shaped outer flange 42 and a disk-shaped inner flange 43 that clamp the cutting blade 21 therebetween. The outer flange 42 may be fixed to the spindle 32 by means of a fixing screw 44 that is threadably engaged with the front end of the spindle 32. The inner flange 43 may be interposed between the cutting blade 21 and a flange portion 32a formed on the spindle 32. The front end portion of the spindle 32 may have a non-circular cross-section. The outer flange 42 and the inner flange 43 may have insertion holes having non-circular shapes conforming to the non-circular sectional shape of the front end portion of the spindle 32. The front end portion of the spindle 32 may be inserted into the insertion holes of the outer flange 42 and the inner flange 43, so that the outer flange 42 and the inner flange 43 may be prevented from rotating relative to the spindle 32. For example, the non-circular cross sectional shape of the front end portion of the spindle 32 may be a shape corresponding to a circular shape with opposite sides cut to form parallel linear edges. Therefore, by tightening the fixing screw 44, the cutting blade 21 may be firmly clamped between the outer flange 42 and the inner flange 43. As a result, the cutting blade 21 can be firmly fixed to the spindle 32.

A cylindrical tubular driven pulley 43a may be formed integrally with the right side portion of the inner flange 43. As shown in FIG. 4, the bearing holder 23a of the housing cover 23 may be positioned on the radially inner side of the driven pulley 43a. Therefore, the left bearing 33 rotatably supporting the spindle 32 may be also positioned on the radially inner side of the driven pulley 43a. In this way, the left bearing 33 overlaps the inner flange 43 with respect to the axial direction of the spindle 32 (the left and right directions as viewed in FIG. 4).

A suitable clearance may be provided between the inner circumferential surface of the driven pulley 43a and the outer circumferential surface of the bearing holder 23a. In this way, the driven pulley 43a and the bearing holder 23a do not interact with each other. Therefore, the driven pulley 43a may rotate together with the spindle 32 on the radially outer side of the bearing holder 23a.

The driven pulley 43a may serve as a driven pulley for the belt transmission mechanism 40. A transmission belt 45 is engaged with the driven pulley 43a and the drive pulley 41 so as to extend therebetween.

With the above construction, the rotation of the electric motor 16 may be transmitted to the intermediate shaft 35 through engagement between the drive gear 16a and the intermediate gear 34. The rotation of the intermediate shaft 35 may be further transmitted to the inner flange 43 via the belt transmission mechanism 40 that includes the drive pulley 41, the driven pulley 43a, and the transmission belt 45. The rotation of the inner flange 43 may be further transmitted to the cutting blade 21 via the spindle 32.

In this embodiment, the drive system 30 may further include a spindle lock mechanism 50. The spindle lock mechanism 50 may include a lock member 51 and a rotational member 52 cooperating with the lock member 51. The lock member 51 may be mounted within the drive housing 31 so as to be movable in an axial direction (the left and right directions in FIG. 4) relative to the drive housing 31. A compression spring 53 may bias the lock member 51 in an unlock direction (rightward in FIG. 4). The rotational member 52 may have a thin disk-like shape and may be fixedly mounted to the spindle 32 so as to rotate together with the spindle 32. A plurality of engaging recesses 52a may be fainted in the outer circumferential edge of the rotational member 52 for engagement with the lock member 51.

Therefore, when the user pushes the lock member 51 in a lock direction which is against the biasing force of the spring 53, the left end portion of the lock member 51 may engage any one of the engaging recesses 52a of the lock members 52. In this way, the rotation of the rotational member 52a and eventually the rotation of the spindle 32 can be locked. Releasing the pushing force applied to the lock member 51 may cause the lock member 51 to move in the unlock direction.

With the spindle 32 locked by the spindle lock mechanism, the fixing screw 44 can rotate easily in the tightening direction and in the loosening direction. In this way, the operation for mounting the cutting blade 21 to the spindle 32 and removing the cutting blade 21 from the spindle 32 can be easily and rapidly performed.

As described above, according to the representative embodiment, the drive system 30 is configured such that the rotation of the electric motor 16 is transmitted to the cutting blade 21 through engagement between the drive gear 16a and the intermediate gear 34 and further through the belt transmission mechanism 40. In this way, no gear is necessary to be provided on the spindle 32, so that an accommodation space for the drive system 30 can be minimized with respect to the axial direction of the spindle 32. This may allow the right side portion of the drive housing 32 to be shifted to the right as compared to the position in the case of the prior art. This is indicated by the difference between the two-dot chain lines and the solid lines in FIG. 4.

In addition, the left bearing 33 rotatably supporting the spindle 32 is positioned on the radially inner side of the driven pulley 43a of the inner flange 43. It overlaps with the driven pulley 43a with respect to the axial direction of the spindle 32 (the left and right directions as viewed in FIG. 4). Therefore, also in this respect, an accommodation space for the drive system 30 can be minimized with respect to the axial direction of the spindle 32.

By providing no gear on the spindle 32 and by positioning the left bearing 33 so as to overlap with the driven pulley 43a, it may be possible to shift the right side portion of the drive housing 31, in particular the right end surface of lower portion of the drive housing 31, can be shifted leftward from the position indicated by the two-dot chain lines to the position indicated by the solid lines in FIG. 4. Therefore, it is possible to determine a right side maximum inclination angle of the cutting unit 10 to be larger than in the known art. This also means that it is possible to perform an inclined cutting operation of a workpiece that that has a higher height than available in the known art.

The above representative embodiment may be modified in various ways. For example, although the left bearing 33 rotatably supporting the spindle 32 is positioned on the radially inner side of the driven pulley 43a so as to overlap therewith with respect to the axial direction of the spindle 32 in the above representative embodiment, this overlapping arrangement may be omitted. Thus, the position of the left bearing 33 may be shifted rightward from the position shown in FIG. 4 so as not to overlap with the driven pulley 43a. Also with this arrangement, as no gear provided on the spindle 32, it is possible to minimize the accommodation space for the drive system 30.

Although the rotational member 52 of the spindle lock device 50 is mounted on the spindle 32 for locking the rotation of the spindle 32, the rotational member 52 can be mounted to any other member than the spindle 32. For example, the rotational member 52 may be mounted to the intermediate shaft 35, so that the rotation of the spindle 32 can be indirectly locked.

Further, a bearing (not shown) may be interposed between the driven pulley 43a and the bearing holder 23a of the housing cover 23 such that the driven pulley 43a is rotatably supported by the bearing holder 23a. In such a case, the spindle 32 may be formed integrally with the driven pulley 43a, and the left and right bearings 33 and 39 can be omitted. With this arrangement, the position of the right side portion of the drive housing 31 may be shifted further leftward to enable a right side maximum inclination angle of the cutting unit 10 to be further increased.

Furthermore, although the cutting device 1 is configured as a table-type cutting device in the above representative embodiment, the present teachings can be also applied to a drive system of a portable circular saw. The portable circular saw may have a base for contacting an upper surface of a workpiece, and a cutting unit that includes a circular saw blade protruding downward through the base for cutting the workpiece during a cutting operation.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved battery packs, and methods of making and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A cutting device comprising:
an electric motor;
a cutting blade;
a clamp device having a first flange and a second flange configured to clamp the cutting blade therebetween; and
a drive system configured to transmit rotation of the electric motor to the cutting blade;
the drive system having a belt transmission mechanism;
wherein the belt transmission mechanism includes a drive pulley, a driven pulley and a belt extending between the drive pulley and the driven pulley; and
wherein the driven pulley is coupled to the first flange of the clamp device.

2. The cutting device according to claim 1, wherein the first flange is positioned on the side of the belt transmission mechanism with respect to the cutting blade.

3. The cutting device according to claim 1, wherein the driven pulley is integrated with the first flange.

4. The cutting device according to claim 3, wherein the driven pulley is formed integrally with the first flange.

5. The cutting device according to claim 1, further comprising a drive housing and a spindle rotatably supported within the drive housing via a bearing;
wherein the cutting blade is mounted to the spindle while the cutting blade is clamped between the first flange and the second flange; and
wherein the bearing is disposed within the drive housing such that the bearing overlaps the first flange in an axial direction of the spindle.

6. The cutting device according to claim 5, further comprising a spindle lock mechanism configured to lock the rotation of the spindle;
wherein the spindle lock mechanism includes a lock member and a rotational member that rotates with the spindle;
wherein the lock member is configured to engage the rotational member.

7. A cutting device comprising:
an electric motor;
a cutting blade;
a clamp device having a first flange and a second flange configured to clamp the cutting blade therebetween; and
a drive system configured to transmit rotation of the electric motor to the cutting blade via the first flange.

8. The cutting device according to claim 7, further comprising a spindle, wherein
the cutting blade is mounted to the spindle while being clamped between the first flange and the second flange.

9. A cutting device comprising:
a cutting unit having an electric motor and a cutting blade rotatably driven by the electric motor via a drive system;
a table having a table surface for placing a workpiece thereon; and
a support mechanism configured to support the cutting unit on the table, so that the cutting unit is tiltable from a vertical position to a left or right tilt position;
wherein when the cutting unit is positioned at the vertical position, a surface of the cutting blade extends vertically relative to the table surface of the table,
wherein the cutting unit further includes a clamp device including a first flange and a second flange configured to clamp the cutting blade therebetween; and
wherein the drive system is configured to transmit rotation of the electric motor to the cutting blade via the first flange.
